(19) United States
(12) Patent Application Publication
(10) Pub. No.: US 2025/0371797 A1
(43) Pub. Date: Dec. 4, 2025

(54) NEURAL VOLUME RENDERING

(71) Applicant: COMMONWEALTH SCIENTIFIC AND INDUSTRIAL RESEARCH ORGANISATION, Acton ACT (AU)

(72) Inventors: Leo Lebrat, Brisbane (AU); Wendy Xiao, Brisbane (AU); Rodrigo Fonseca Santa Cruz de Oliveira, Brisbane (AU); David Ahmedt Aristizabal, Canberra (AU)

(21) Appl. No.: 19/220,729

(22) Filed: May 28, 2025

(30) Foreign Application Priority Data
May 28, 2024 (AU) 2024901580

(51) Int. Cl. G06T 15/20; G06T 7/70

(52) U.S. Cl. CPC G06T 15/205; G06T 7/70; G06T 2207/20084

(57) ABSTRACT

This disclosure relates to generating a three-dimensional representation of a scene using a neural radiance field. In some embodiments, a method includes accessing multiple training images of the scene, each of the multiple training images imaging the scene from a different view, the multiple training images comprising a first subset of selected training images and a second subset of remaining training images; calculating a distance value between each of the first subset of the selected training images and each of the second subset of the remaining training images; adding one of the multiple training images from the second subset of the remaining training images to the first subset of the selected training images based on the distance value to create a training set of the training images; training a neural radiance field using the training set; and generating a three-dimensional representation of the scene using the neural radiance field.

### CROSS REFERENCE TO RELATED APPLICATIONS

The present application claims priority to Australian Patent Application No. 2024901580, filed May 28, 2024, the entire contents of which are incorporated herein by reference.

### TECHNICAL FIELD

This disclosure relates to generating a three-dimensional representation of a scene using a neural radiance field.

### BACKGROUND

Three dimensional representations of scenes can be generated by neural radiance fields. However, the generation often requires significant computational resources and/or is inaccurate.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

A method for generating a three-dimensional representation of a scene comprises:
accessing multiple training images of the scene, each of the multiple training images imaging the scene from a different view, the multiple training images comprising a first subset of selected training images and a second subset of remaining training images;
calculating a distance value between each of the first subset of the selected training images and each of the second subset of the remaining training images;
adding one of the multiple training images from the second subset of the remaining training images to the first subset of the selected training images based on the distance value to create a training set of the training images;
training a neural radiance field using the training set; and
generating a three-dimensional representation of the scene using the neural radiance field.

In some embodiments, calculating the distance value comprises calculating a distance between camera positions from which the multiple training images are captured.

In some embodiments, calculating the distance value comprises calculating a great-circle distance between the camera positions.

In some embodiments, calculating the distance value comprises calculating an Euclidean distance between the camera centres.

In some embodiments, calculating the distance value comprises calculating a pair-wise view similarity.

In some embodiments, the pair-wise view similarity is indicative of a number of points in a point cloud calculated from the multiple training images.

In some embodiments, adding one of the multiple training images comprises creating a probability function for each of the multiple training images and sampling the probability function to select one of the multiple training images.

In some embodiments, adding the one of the multiple training images comprises incrementally adding the one of the multiple training images and training the neural radiance field at each iteration.

In some embodiments, adding the one of the multiple training images is based on information gain of that training image.

In some embodiments, adding the one of the multiple training images is based on a random selection of elements that are weighted based on the distance value.

In some embodiments, the random selection comprises a Zipf sampler.

In some embodiments, the random selection comprises a von Mises-Fisher sampler.

In some embodiments, the method further comprises applying a quantisation algorithm to uniformize placement of the views of the selected training images.

In some embodiments, the method further comprises generating an output image of the scene based on the three-dimensional representation.

In some embodiments, the output image is from a user-defined view different from the view of each of the multiple training images.

Software, when executed by a computer, causes the computer to perform the above method.

A computer system comprising one or more processors configured to perform the above method.

### BRIEF DESCRIPTION OF DRAWINGS

An example will now be described with reference to the following drawings:

FIG. 1 illustrates a method for generating a three-dimensional representation of a scene.

FIG. 2 illustrates an example scene.

FIG. 3 illustrates different subsets of training images.

FIG. 4 is an overview of the disclosed methods. (a) Different test camera selections result in different error measurements on the reconstructed object, which ultimately can result in SOTA ranking inversion. (b) In a synthetic setting and for InstantNGP, a better view selection algorithm such as farthest view sampling (FVS) can reach 33 dB of PSNR using only 70 training views, whereas random sampling (RS) would require 150 views to achieve similar performances. (c) With 25% fewer views, the disclosed view selection method outperforms random view selection.

FIG. 5: Ranking the rendering performance of four distinct NeRF models under various z-axis rotations of the test camera poses. Left: original test set. Right: proposed test set.

FIG. 6: Visual comparison between original (left) and proposed (right) test set for NeRF Synthetic dataset. The top row visualizes the default (w/o. rotation) test cameras' distribution in the 3D space. The bottom displays the absolute difference of the coverage density measure between default and 900. A lighter color indicates higher discrepancies in terms of the standard deviation σ.

FIG. 7 illustrates a Farthest View Sampling algorithm.

FIG. 8 illustrates a Heuristic Sampling algorithm.

FIG. 9 provides quantitative comparisons of rendering quality along with the increase of used training views sampled by different view selection methods. Top: results on the NeRF Synthetic dataset in terms of PSNR (a) and SSIM (b). Bottom: results on the TanksAndTemples dataset in terms of PSNR (c) and SSIM(d). Low-opacity lines present the results for each repetition, while high-opacity lines present the average result across five repetitions.

FIG. 10 illustrates ablation studies of the information type on the TanksAndTemple dataset.

FIG. 11 illustrates ablation studies of the sampling strategy in HS on the TanksAndTemple dataset.

FIG. 12 illustrates ablation studies of different distance metrics in FVS (c) on the TanksAndTemple dataset.

FIG. 13: Comparison results between fvs (d_{euc}) and fvs (d_{euc}+dₚₕₒₜₒ) in terms of PSNR on the scene Playground.

FIG. 14 illustrates a computer system for generating a three-dimensional representation of a scene.

FIG. 15 illustrates the rendering performance of four distinct NeRF models, in terms of PSNR, under various z-axis rotations of the test camera poses. Left: original test set, Right: proposed test set.

### DESCRIPTION OF EMBODIMENTS

This disclosure provides methods for selecting an optimal set of training images for training neural radiance fields. With this optimal set, a smaller number of images can be used, which speeds up the training process and/or improves output accuracy (i.e. reduces the training error).

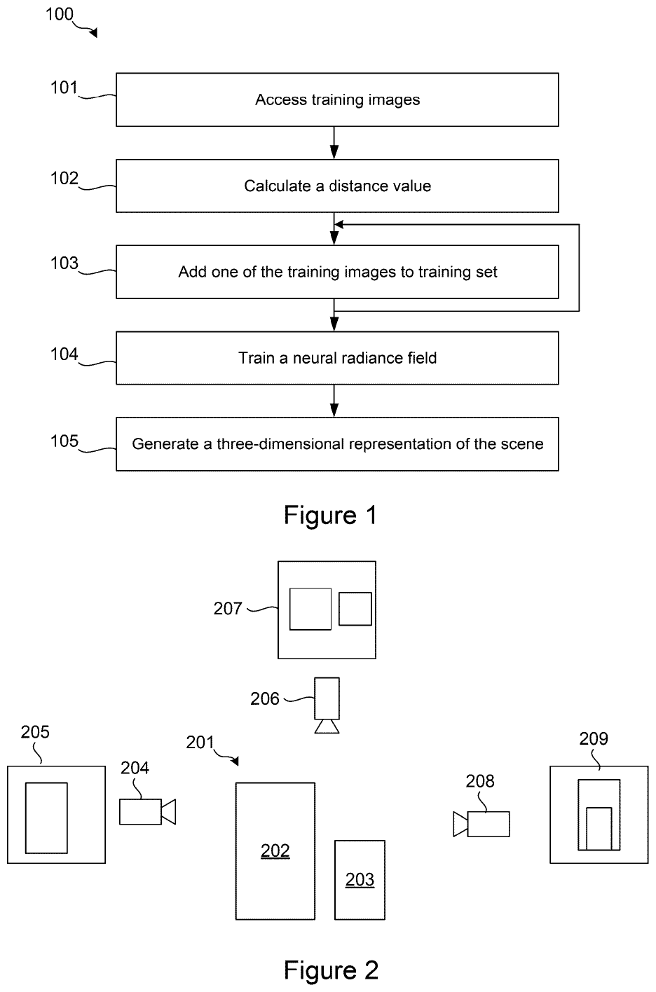

FIG. 1 illustrates a method 100 for generating a three-dimensional representation of a scene. This can be considered as the inverse problem to rendering an image from a three-dimensional representation of a scene. More particular, the aim is to use a set of images from different view-points, a three-dimensional representation of the scene.

The three-dimensional representation comprises data that defines the objects in the scene in three dimensions, such that the objects are defined in a three-dimensional space. In most examples, this is not a description of the individual objects because the disclosed method does not necessarily detect objects. Instead, the disclosed method calculates a representation that describes the entire scene in three dimensions in a parametric manner, for example. The are various different forms or primitives of the three-dimensional representation, including different coefficients for each voxel point, spherical harmonics, or other learnable continuous or discontinuous functions. Those harmonics and functions have the advantage that the number of parameters is smaller than for voxel coefficients. Therefore, training and evaluating the model is significantly faster.

The three-dimensional representation may also comprise a continuous radiance field. A continuous radiance field is a function that models the light emitted from every point in a scene as a continuous variable. This function is defined over a continuous domain, meaning it can predict the radiance for any point in space, not just at discrete intervals or locations. The field is characterized by its ability to capture the complex interplay of light within a scene, including how light scatters and reflects off surfaces and objects.

The term “parameterized” refers to the method by which the function is defined. In this context, a deep neural network (DNN) may be used to parameterize the radiance field. A DNN is a type of artificial intelligence that consists of multiple layers of interconnected nodes, or “neurons,” which can learn complex patterns in data. The radiance field is parameterized by a DNN in the sense that the DNN is used to approximate the function that defines the radiance at any given point.

The DNN takes as input spatial coordinates (x, y, z) and viewing direction angles (θ, ϕ), and outputs the predicted radiance and volume density at that point. The viewing direction is included because the appearance of an object can change based on where the observer is looking from, due to phenomena like specular reflection and refraction.

Mathematically, the radiance field (L) at a point (p) with coordinates (x, y, z) and viewing direction (v) can be expressed as:

$$L ( p , v ) = DNN ( x , y , z , θ , ϕ )$$

where (DNN) represents the deep neural network, and (θ, ϕ) are the Euler angles that define the viewing direction.

The network is trained using the selected training images of the scene from various viewpoints. During training, the DNN learns to predict the correct radiance values that would recreate the selected training images when rendered from their respective viewpoints. This process involves adjusting the weights of the neurons in the network to minimize the difference between the predicted and actual images, a process known as backpropagation.

From the three-dimensional representation, it is possible to derive further outputs, such as mesh, colour from pixels, or other functions. Further, the three-dimensional representation can be used to generate (render) an image of the scene from a new view point that was not in the training images.

When reference is made to a view point herein, this is meant to be a reference to a view point of a camera or an imaginary camera. For example, the view point may be defined by three location parameters to define the camera location and two angle parameters to define the camera viewing direction. In further examples, the view point may also involve a focal length of field of view as an angle or in millimetres. It is noted that view points may be synthetic in the sense that they are configured in a virtual environment. It is further noted that in this disclosure, the terms “view” and “image” are used interchangeably.

Method 100 commences by accessing 101 multiple training images of the scene. These training images are two-dimensional images, such as photographs. The images may comprise digital image data and may be in a digital image format, such as joint photography group (JPG) or bitmap (BMP) or other format. In some examples, the training images are three channel colour images with a red, green, and blue (RGB) channel. In other examples, the images are monochrome, infrared, or multispectral images. The scene may be illuminated by natural light or from an artificial light source.

FIG. 2 illustrates a scene 201 comprising a larger box 202 and a smaller box 203. A first camera 204 captures scene 201 from the left to generate a first image 205, which only shows the larger box 202 because from the view point of the first camera 204, the second box 203 is not visible. Similarly, a second camera 206 captures a second image 207 in which the larger box 202 and the smaller box 203 are captured from the top showing a gap between them. Finally, a third camera 208, captures a third image 209 in which the smaller box 203 can be seen in front of the larger box 202. FIG. 2 illustrates intuitively how each view point provides different information about the scene and the objects in each scene. It further illustrates that some objects are only visible from some view points. It is possible to use a single moveable camera to capture the first image 205, second image 207 and third image 209.

It is also possible to capture further images while moving the camera at multiple positions between the positions shown in FIG. 2. In this sense, the number of acquired images can be effectively unlimited. However, as is shown further below, the images are used as input into training a model and the training time depends on the number of training images. Therefore, it is not desirable to use an excessively large number of training images. In other words, it is not the capturing of the training images that is the difficulty but the processing of the training images.

So instead of using an excessively large number of training images (brute force approach), it would be desirable to choose a smaller number of training images for training. However, the optimal selection of training images may be different for each scene. In the example of FIG. 2, images that are taken from a similar view point to first camera 204, will only show the large box, so they will add a small amount of additional information. In contrast, images that are taken from a similar view point to third camera 208 will show the smaller box 203 in different relative position to the larger box. Therefore, each additional image will add a large amount of additional information.

Therefore, this disclosure provides methods for selecting training images to train the model more efficiently. More formally the multiple training images comprise a first subset of selected training images and a second subset of remaining training images. The term subset in this context refers to a set, group or collection of images that is part of the entire set. A subset may include no image, some images or all images of the entire set. At the beginning of the method, one or multiple (e.g., a small number of) training images may be selected randomly to be in the first subset of selected training images.

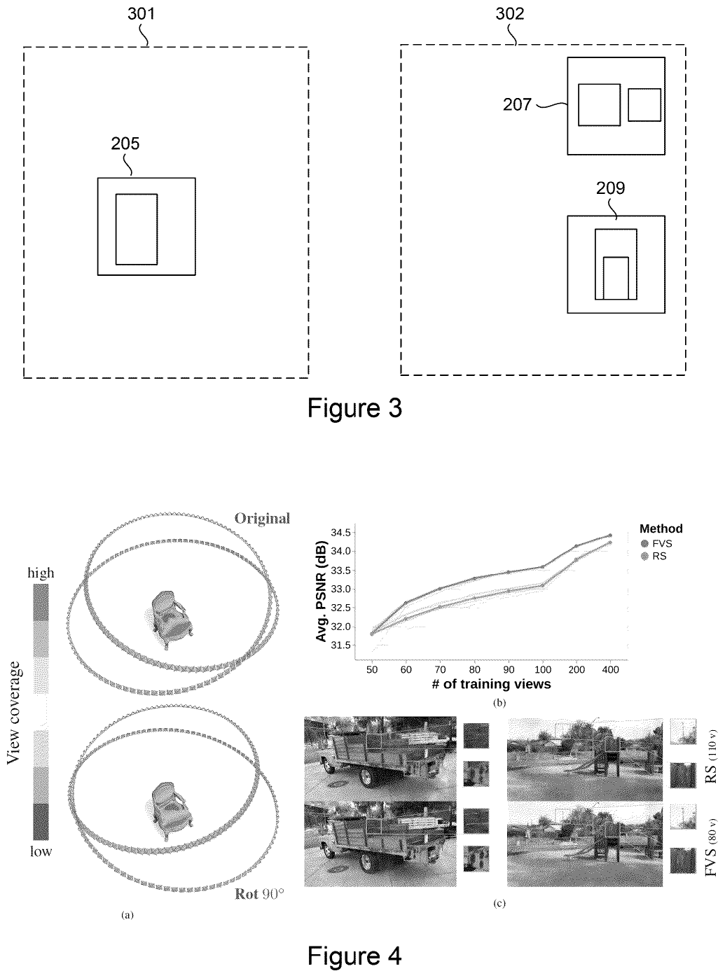

FIG. 3 illustrates the different subsets of training images. Here, the first image 205, the second image 207 and the third image 209 are considered training images and together they form a set of training images or a set of available training images. There is a first subset 301 of selected training images, which currently contains only the first training image 205, which was selected randomly as the initial training image. So the first subset contains images that are selected as training data to train the model. As before, the first training image 205 selected in the first subset 301 shows the larger box 202 but has no information about the smaller box. There is a second subset 302 of remaining training images, which contains second image 207 and third image 209. So the second subset contains images that are not selected yet but may be selected in a further iteration. The aim is now to select the best image from the second subset 302 and add it to the first subset 301 to improve the results of the training of the model.

To this end, the method 100 calculates 102 a distance value between each of the first subset 301 of the selected training images and each of the second subset 302 of the remaining training images. So in this example, method 100 calculates the distance between first image 205 and second image 207. As well as the distance value between first image 205 and third image 209. The distance value can take various different forms as provided below, including distance on a great circle, Euclidean distance, entropy or probabilistic distance, distance with respect to the covered scene area and others. Further, the distance value may not necessarily be an explicit one-to-one measure but may measure the distance of remaining images to the selected images in total. So there is only one distance value for each remaining image, but that is still between each of the selected training images and that remaining image because there may be an aggregate representation of the selected training images.

In some examples, the method 100 calculates a distance value between each of the first subset of the selected training images and each of the second subset 302 of the remaining training images by calculating a distance between camera positions from which the multiple training images are captured. Each camera position defines the location of the camera in the scene and may be defined by a camera centre point. The position may be in x, y, z coordinates or in latitude, longitude, elevation or other three-dimensional coordinates.

In some examples, the camera positions of the cameras may lie on a sphere and in that case, calculating the distance value comprises calculating a great-circle distance between the camera positions. In other examples, where the camera positions may not be on a sphere but arbitrarily located in the scene, calculating the distance value comprises calculating an Euclidean distance between the camera centres.

In yet a further example, the method 100 calculates the distance value between each of the first subset 301 of the selected training images and each of the second subset 302 of the remaining training images by calculating a pair-wise view similarity. This pair-wise view similarity represents a similarity between the views from the two camera positions of that pair. So a first image from a first camera position generates a first view and a second image from a second camera position generates a second view. In this sense, the first camera and the second camera form a pair for calculating the pair-wise view similarity. The method then calculates a similarity between the first view and the second view. In one example, the method creates a matrix that contains the similarity between every view and every other view.

The pair-wise view similarity may be indicative of a number of points in a point cloud calculated from the multiple training images. For example, there may be a 2D feature correspondence between the first image from the first view and the second image from the second view. The method may then triangulate the corresponding features and count the number of three-dimensional points in the sparse point cloud. The similarity measure may then be that count or a number derived from that count. The sparce point cloud may be calculated using a structure-from-motion algorithm.

The method then adds 103 one of the multiple training images from the second subset 302 of the remaining training images to the first subset 301 of the selected training images based on the distance value to create a training set of the training images. The method may repeat this step until a sufficient number of images is selected.

Selecting based on the distance value means that the method may comprise applying a function to the distance value to determine a selection criteria. In other examples, the method comprises selecting the image from the second set that has the largest distance value. This way the image that likely contributes the most additional information is added to the training set. The method may also add more than one image, such as by adding images by applying a threshold on the distance value. This way, the method may add all images that are above the threshold. This way, the method adds multiple images at a time. The distance value may also be an inverse of a different value. For example, the distance value may be the similarity value and the method selects the images with the lowest similarity value.

In cases where multiple images are in the first sent 301, then method 100 may comprise calculating the distance value between each of the images in the first set 201 and each of the images in the second set 302 by calculating the distance value between an image in the second set and a combined measure over all the images in the first set 301. For example, the triangulated corresponding features may be the features from all the images in the first set 201 in a single representation and then the method can determine the count of 3D points in than triangulated representation.

In a further example, the method 100 comprises adding 103 one of the multiple training images from the second subset 302 of the remaining training images to the first subset 301 of the selected training images based on the distance value to create a training set of the training images by creating a probability function for each of the multiple training images. The method 100 then comprises sampling the probability function to select one of the multiple training images. That is, the probability function is a function of the positions of the training images and the method comprises drawing a sample from the probability function to select one camera position. In other examples, the probability distribution is over the entire space of possible camera positions (such as a sphere or the entire Euclidean space) and the method draws a sample from that probability distribution. Since it is unlikely that there is a camera position exactly at the sampled position, the method comprises selecting the image that is taken from a position that is closed to the sampled position. More information is provided further below.

Once the training images are selected, the method comprises training 104 a neural radiance field using the training set. A neural radiance field is an output of a neural network that takes the camera position as input. The camera position may comprise the three location parameters (x, y, z). The camera position may further comprises the 2D viewing direction (θ, ϕ) to form a 5D input. The radiance field, e.g., the output of the neural network, may comprise colour values (r, g, b) and volume density a. However, other formats and parameters may be possible as the output of the neural network. In one example, the neural network is a multi-layer perceptron (MLP). The MLP first processes the input 3D coordinate x with 8 fully-connected layers (using ReLU activations and 256 channels per layer), and outputs σ and a 256-dimensional feature vector. This feature vector is then concatenated with the camera ray's viewing direction and passed to one additional fully-connected layer (using a ReLU activation and 128 channels) that output the view-dependent RGB color. The 5D neural radiance field represents a scene as the volume density and directional emitted radiance at any point in space. The color of any ray passing through the scene can be rendered using principles from classical volume rendering. The volume density σ (x) can be interpreted as the differential probability of a ray terminating at an infinitesimal particle at location x.

Training the neural radiance field comprises updating parameters of a model to minimise an error between the model output and the training data. This may involve backpropagation and gradient descent methods. The model may be configured to predict a three-dimensional representation of the scene and the training data also comprises a three-dimensional representation of the scene. The training then comprises optimising the model parameters to reduce the error between both representations. As stated above, the representations may be image values, such as RGB values, of voxels in the image, which may also comprise volume density. The representation may be along a camera ray, on a different shape or across the entire scene.

Finally, the method comprises generating 105 a three-dimensional representation of the scene using the neural radiance field. This may involve rendering a novel view of the scene as an image, a parameterised representation of the scene or any other three-dimensional representation.

### Motivation—Providing a Robust Evaluation

This section analyzes the importance of view selection whilst evaluating different NeRF models and illustrates the motivation for investigating an effective view selection algorithm for neRF. To carry out this experiment, the NeRF Synthetic dataset were used, where cameras follow a trajectory resembling a lemniscate in the original test set. Using Blender files, 12 additional test sets were generated by rotating the original cameras according to z-axis.

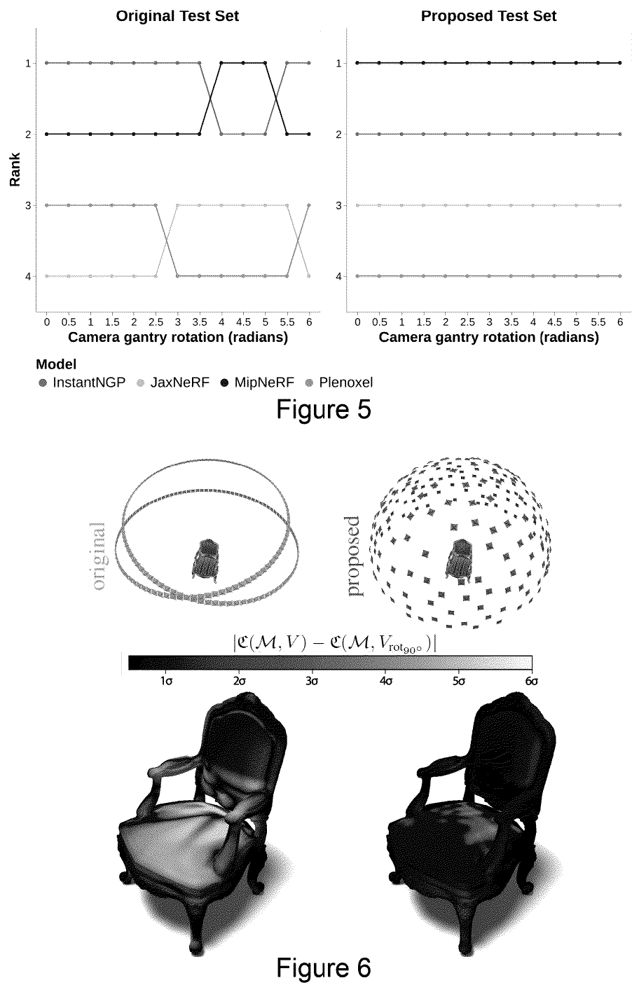

The method for training image selection can be used in conjunction with different models that calculate neural radiance fields, noting that improvements can be achieved for all of those models. This disclosure compares the performance of different models, including NeRF, MipNeRF, Plenoxels and InstantNGP, which can be used with the disclosed methods for training image selection. Performance is evaluated across 13 sets of distinct camera poses. These models are ranked based on their average peak signal-to-noise ratio (PSNR) on each separate test set as visually presented in FIG. 5. Notably, the ranking exhibited variations across various rotation scenarios; for instance, while InstantNGP excelled on the reference test pose, it was outperformed by MipNeRF in certain rotation scenarios.

To gain a deeper understanding of the impact of camera selection, this disclosure introduces the coverage density measure, supported on the mesh M. Given a set of n-views V={v₁, . . . , vₙ} with associated rays

$${r}_{j , k}^{i}$$

for the j,k-th pixel of the i-th view, the coverage measure C is defined by,

$$C ( M , V ) = \frac{1}{K} {\sum }_{l = 1}^{M} {δ}_{{x}_{l}} W ( M , V , {x}_{l} ) , \qquad ( 1 )$$

$$W ( M , V , {x}_{l} ) = \vert ( {\sum }_{i = 1}^{n} {\sum }_{{1 \leq j \leq H}_{1 \leq k \leq W}} ( {r}_{j , k}^{i} {∩}^{1} M ) ) ⋂ {B}_{2}^{ℓ} ( {x}_{l} ) \vert ,$$

with K a normalization factor, (xₗ)_{I∈1 . . . M} a uniform point-cloud discretizing M, where

$${B}_{2}^{ℓ} ( x )$$

is the L₂-ball of radius [symbol] centered in x and r ∩¹ M denotes the first intersection between the ray r and the mesh M. C(M, V_{default}) and C

$$( M , {V}_{{rot}_{90 °}} )$$

is displayed in FIG. 4 (a).

To circumvent the biased evaluation methodology, this disclosure provides a new uniform test set where all cameras are equally distributed on a sphere centered on the reconstructed object and displayed in the FIG. 6(top). The method disclosed herein visualizes the absolute difference of C(M, V_{default}) and C

$$( M , {V}_{{rot}_{9 {0}^{∘}}} )$$

for the original and the proposed test set in FIG. 6 (bottom). The proposed test set provides an even coverage of the scene, and thereby, effectively enables a robust evaluation shown in FIG. 5 (right).

### Image Selection

This disclosure provides strategies to achieve optimal rendering quality by selecting training views from an extensive collection of images by adding training images to a subset of selected training images. Formally, given a set of training images, a respective set of training views V={v₁, v₂, . . . , v_{N}} and a target view budget n, an objective is to select a subset of training views S that maximizes the rendering performance Q of NeRF. This problem can be formally defined as,

$$arg {max}_{S ⊆ V} Q ( S ) , \qquad ( 2 )$$

where |S|=n. To tackle this problem, this disclosure proposes a method that calculates a distance value between each of the already selected training images and each of the remaining training images in order to add one of the remaining training to the subset of the selected training images based on the distance value. There are different strategies for adding images to the selected images based on the distance value and this disclosure provides two examples referred to as farthest view sampling (FVS) and heuristic sampling (HS).

### Farthest View Sampling

The Farthest point sampling (FPS) algorithm is adapted for the view selection problem, aiming to efficiently capture features of the target scene by selecting representative views that are as different from each other as possible.

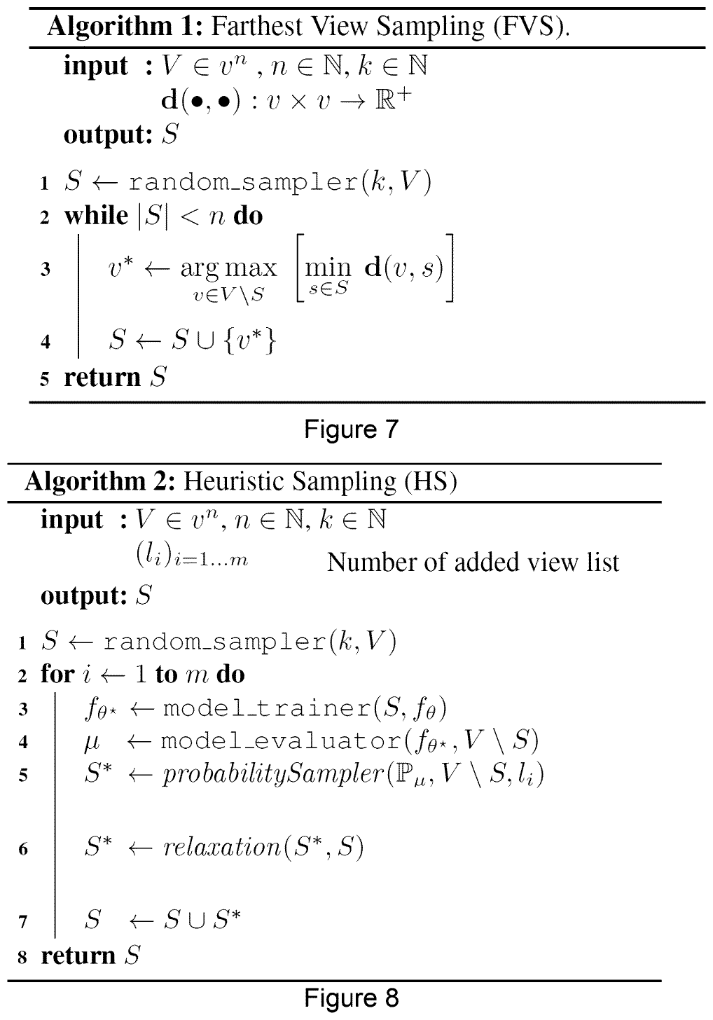

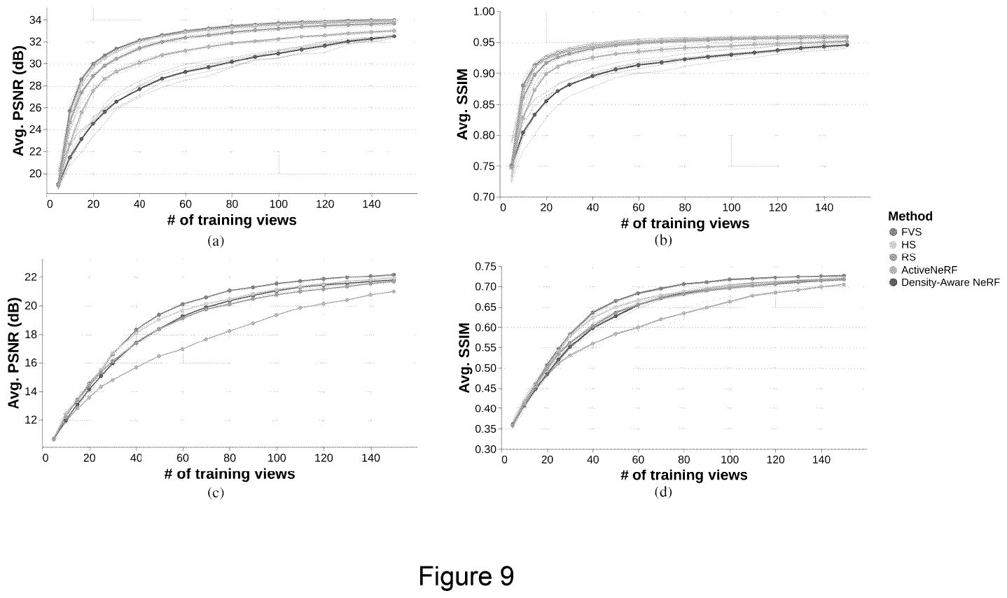

Algorithm 1 in FIG. 7 outlines the FVS. Given a large set of training views V and an initially selected subset of views S, FVS first identifies the nearest selected neighbor of each point in the remaining set V\S (V excluding S). The algorithm then selects the candidate view with the maximum distance as the next addition to the subset S. The employed distance metric considers both the spatial expansion of cameras and the diversity of scene features captured by views.

### Spatial Expansion of Cameras

The method measures the spatial distance across cameras, denoted as dₛₚₐₜᵢₐₗ, by evaluating the distance between the camera centers of the candidate view cᵥ, and the selected view's camera center cₛ. Once all training views are captured from a common sphere, the great-circle distance d_{gc} is used as a metric. The distance is defined as,

$${d}_{gc} ( {c}_{v} , {c}_{s} ) = arccos ( {c}_{v} \cdot {c}_{s} ) . \qquad ( 3 )$$

In cases where training cameras are distributed throughout the scene, the Euclidean distance is employed to measure spatial separation,

$${d}_{e u c} ( {c}_{v} , {c}_{s} ) = {‖ {c}_{v} - {c}_{s} ‖}_{2}^{2} . \qquad ( 4 )$$

### Scene Diversity Depicted in Views

In an uncontrolled environment, the training images' perspective can be skewed away from the scene's central point, leading nearby cameras to capture entirely different visual content of the scene, e.g. two cameras at the same position orienting in two different directions. To address this challenge, this disclosure leverages the sparse 3D point cloud and 2D image correspondences computed by the underlying Structure from Motion (SfM) algorithm used to generate the poses of the training images.

Let A ∈N^{N×N} be a symmetric matrix of pair-wise view similarities. The similarity Aᵢⱼ is the count of 3D points in the SfM's sparse point cloud, triangulated from 2D feature correspondences between views i and j. This measure takes into account visual content, field of view, and relative camera positioning between views. Then, using A, the view photogrammetric distance dₚₕₒₜₒ, is defined as,

$${d}_{p h o t o} ( {v}_{i} , {v}_{j} ) = 1 - \frac{{A}_{i j}}{max ( A )} . \qquad ( 5 )$$

Overall, the view distance value d(•, •) is composed of two parts —dₛₚₐₜᵢₐₗ considering the spatial distance between camera centers of two views (either d_{gc}, or d_{euc}) and dₚₕₒₜₒ representing the difference in perception content about the scene. It can be expressed as,

$$d ( \cdot , \cdot ) = {d}_{spatial} + α {d}_{p h o t o} , \qquad ( 6 )$$

where α is a positive hyper-parameter associated to photogrammetric distance.

### Information Gain-Based (Heuristic) Sampling

While FVS selects n views from V based on a metric d without training a NeRF model, heuristic sampling (HS) is an incremental procedure deriving information gain from a checkpointed model to select novel views. As detailed in Algorithm 2 in FIG. 8, HS begins by randomly sampling k views from V to establish the initial set of training images, or training views S. Subsequently, at each iteration i, it trains a NeRF model on S and evaluates the remaining images (views) in V\S. Employing different evaluation measures and sampling algorithms, it calculates a distance value and augments the current training set S by selecting lᵢ novel views from V\S based on the distance value. Optionally, a density relaxation step can be performed on this augmented training set. This process continues until n new views are selected.

### Sampling Views Maximizing Information Gain

The heuristic-based procedure comprises two components: the definition of information gain and the method for sampling views according to this quantity. It is noted that the information gain is also referred to as a distance value because it is indicative of the distance in information between the selected and the remaining images. The sampling method is then based on this distance value representing information gain.

### Target Density Construction:

This disclosure proposes to measure the error (also referred to as distance value), in terms of the PSNR ranking, for every single remaining training view.

Sampling from the Remaining View:

The method disclosed herein first introduces the Zipf view sampler. Given a set of q views {v₁, . . . , v_{q}} with associated error or uncertainty measurements (distance values) m=(m₁, . . . , m_{q}), the greedy selection k is defined as,

$${S}^{*} {:}^{{}^{{}_{k}}} Z exp ( m ) , \qquad ( 7 )$$

where:^{k} describes the random selection of k elements without replacement, and Z exp is a Pareto-Zipf law with exponential weighting. The probability mass function is defined by,

$${f}_{t} ∝ \frac{{e}^{- γ \frac{r a n k ( {m}_{i} )}{q - 1}}}{{K}_{q}} , \qquad ( 8 )$$

with K_{q} a normalization factor, and γ a hyper-parameter controlling the sampling randomness.

As another approach to exploring possible interactions between nearby error measurements within a probabilistic framework, this disclosure introduces the M-vMF view sampler. This sampler is built on a categorical mixture of the von-Mises-Fisher (vMF) distribution. This sampler assumes that each already sampled view induces a vMF distribution centered at its respective camera position on the unit sphere. The probability density function of this mixture model is given by,

$$f ( x ; v , m , κ ) = {\sum }_{i = 1}^{q} {α}_{i} g ( x ; {v}_{i} , κ ) , \qquad ( 9 )$$

where g(x′, vᵢ, κ) is the induced vMF probability density function for view vᵢ, with a shared concentration hyper-parameter κ. The parameter κ regulates the dispersion of the distributions around their mode at the camera center of vᵢ. As κ→∞ the vMF density approaches a delta function located at vᵢ 's camera center; conversely, when κ→0 this method is equivalent to a uniform distribution over a unit-sphere. Mathematically,

$$g ( x ; {v}_{i} , κ ) = {c}_{3} ( κ ) exp ( κ {v}_{i}^{T} x ) , \qquad ( 10 )$$

where c₃(κ) is the standard vMF normalization term. The blending of these vMF components is controlled by the weights α=(α₁, . . . , α_{q}), obtained through a softmax function applied to distance values m with a temperature parameter σ. Specifically,

$${α}_{i} = \frac{exp ( \frac{{\hat{m}}_{i}}{σ} )}{{\sum }_{j = 1}^{q} exp ( \frac{{\hat{m}}_{j}}{σ} )} , \qquad ( 11 )$$

where

$${\hat{m}}_{i} = \frac{max ( m ) - {m}_{i}}{max ( m ) - min ( m )}$$

is an inverse ranking function of the view's error, min-max normalized between zero and one.

To sample a new view location using this model, the method begins by sampling from the categorical distribution controlled by α. Subsequently, we the method samples a 3D point from the corresponding vMF distribution. As this process does not ensure the existence of a view at the sampled location, the method assigns the closest view in V\S as the sampled view. Within this framework, regions with views of higher errors are more likely to be sampled.

### Avoiding Oversampling Complex Object Parts

It is observed that purely greedy approaches may produce clusters of cameras in particular regions of the 3D space. Indeed, a scene may comprise more challenging parts to learn by neural-rendering primitive. Uncertainty or error may be more substantial for this specific scenario, resulting in Algorithm 2's proposal of novel training views clustering in this area. This over-exploitation behavior is detrimental; empirically observing that it can lower the performance of the view proposal algorithm below that of the baseline RS. To tackle this problem, this disclosure introduces a relaxation step after the proposal of novel views via the view sampler, as described in Algorithm 2. Adapting the Lloyd-Max algorithm to uniformize the placement of the newly proposed camera.

The Lloyd-Max algorithm, also referred to as the Lloyd's algorithm or Max quantizer, is a method used in signal processing for optimal scalar quantization of a continuous distribution of values. The Lloyd-Max algorithm is designed to minimize the quantization error, which is the difference between the input values and the quantized output values. It does this by iteratively adjusting the positions of quantization levels (or “bins”) and the reconstruction values (or “centroids”) to best fit the input data's probability distribution.

The algorithms chooses an initial set of quantization levels, which could be evenly spaced or based on some heuristic. For each quantization level, the algorithm determines the range of input values (partition) that will be mapped to it. This may be done by finding the midpoint between adjacent reconstruction values. The algorithm updates each reconstruction value to be the centroid (mean) of the input values that fall within its partition. This minimizes the mean squared error for that quantization level. The algorithm then calculates the total quantization error for the current iteration. If the change in error from the previous iteration is below a certain threshold, or after a set number of iterations, the algorithm terminates. The final set of partitions and reconstruction values represent the quantizer design.

More specifically, the methods disclosed herein builds a uniform probability distribution whose support is defined by the convex hull of all available training cameras. After the Voronoi tessellation construction, this distribution is used to compute each cell's centroid. Voronoi tessellation, also referred to as a Voronoi diagram or Dirichlet tessellation, is a way of dividing space into a number of regions. A set of points (called seeds, sites, or generators) is specified, and for each seed there is a corresponding region consisting of all points closer to that seed than to any other. These regions are called Voronoi cells. The methods disclosed herein applies the Lloyd iteration only to the new subset of camera S*. More details on the implementation can be found below.

### Computer System

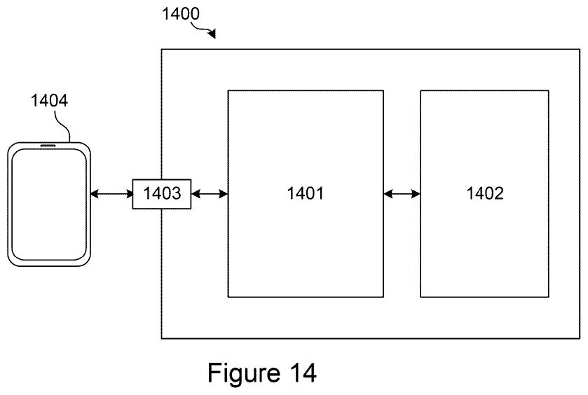

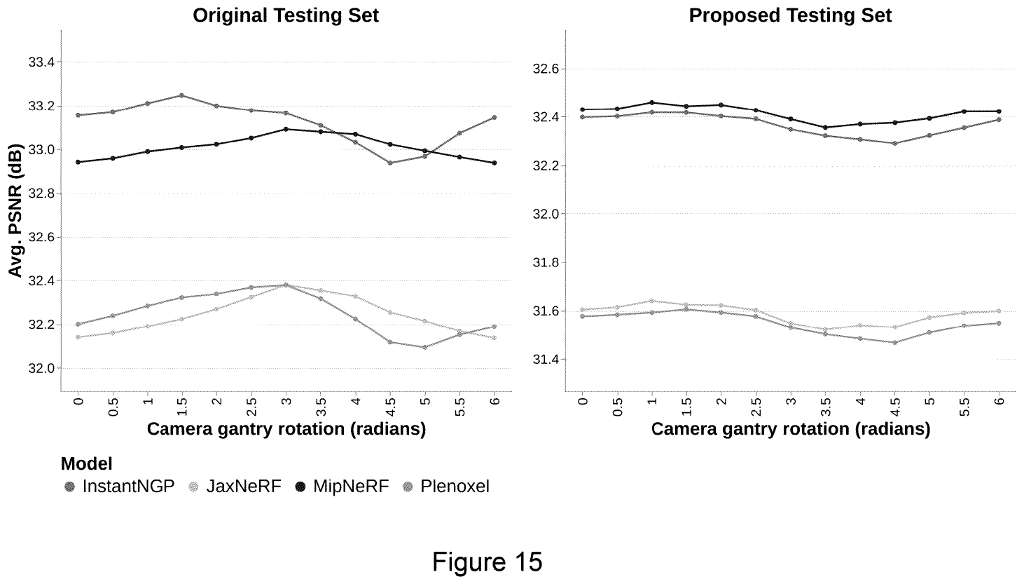

FIG. 14 illustrates a computer system 1400 for generating a three-dimensional representation of a scene. The computer system comprises a processor 1401 and memory 1402. The memory 1402 may comprise a non-volatile or non-transitory computer-readable medium with program code stored thereon to cause the processor 1401, when executing the program code, to perform the methods disclosed herein. In that sense, processor 1401 accesses multiple training images, which may be stored on memory 1402. In other examples, the processor 1401 receives the training images via a communication port 1403 (such as Universal Serial Bus (USB), Bluetooth, Wi-Fi, Internet connection etc.) from a camera. In this example, the camera is integrated into a portable communication device 1404, such as a smart phone. A user (not shown) moves the portable communication device 1404 around a scene to take training images of the scene from different viewpoints. The processor 1401 accesses those training images from the mobile communication device 1404.

The processor 1401 defines one subset of selected training images and one subset of remaining training images. Processor 1401 then calculates a distance value between each of the selected training images and each of the remaining images and adds a remaining image for training based on the distance value. Finally, processor 1401 trains the NeRF using the selected training images and generates the three-dimensional representation.

The processor 1401 may also be implemented as a distributed computing architecture (cloud architecture), may be integrated into the mobile communication device 1404 or may be any other processor architecture. The processor may be programmed by software code, or may be implemented at least in part, by a dedicated circuit, such as a field-programmable gate array or an application specific integrated circuit. In particular, the processor 1401 may be implemented with dedicated circuitry for training neural network models.

It is noted that the processor 1401 may also be integrated into mobile communication device 1404 so that the device that captures the training images is also the same device that performs the methods disclosed herein. It is further noted that with the disclosed method of image selection, fewer computing resources are required for training the model because fewer images are used for the training. This means the training time and energy spent on training is reduced. At the same time, the quality of the three-dimensional representation is improved.

Processor 1401 may further use the three-dimensional representation to generate (or render) an image from an view that was not in the original training set. A user may then modify the view, such as by dragging a mouse or by dragging a finger over a touchscreen. Processor 1401 then continuously generates for every incremental view update during dragging, the output image. As a result, the user experience is that of rotating three-dimensional objects in the scene. The user may also change the camera position and field of view (zoom) and the processor 1401 generates the images accordingly using the three-dimensional representation.

### Experiments

### Experimental Setup

Two datasets were used for experiments: NeRF Synthetic and TanksAndTemples.

### NeRF Synthetic:

It contains 5 synthetic objects. The exact rendering settings were reproduced and the original image resolution kept. Each scene comprises 200 test images sampled and a pool of 300 views evenly distributed for training. We generated ten training sets to ensure reproducibility and statistical significance.

### TanksAndTemples:

It is a real-world dataset containing 4 scenes. Each scene comprises 251 to 313 training images and 25 to 43 test images. Due to significant bias in the testing view, we opted to combine original training and test images and resplit them while keeping the same number of test images for each scene. We followed the method described in Algorithm 1 to sample the new test set and kept the rest of the views for training.

### Backbones and Evaluation Metrics:

We conducted our experiment and analysis based on two NeRF models—InstantNGP and Plenoxels. As evaluation metrics, this disclosure considers peak signal-to-noise ratio (PSNR)(↑) and structural similarity index measure (SSIM)(↑).

### Implementation Details

We conduct a series of experiments with five repetitions using different random seeds and varying training/test sets for synthetic scenes. The process begins by randomly selecting an initial set of 5 views. Subsequently, we add 5 more views in each step, reaching a total of 30 views. The view selection process continues by adding 10 more views at each step until accumulating a total of 150 views. We train each model from scratch for each view selection choice and report novel-view rendering performance on our test set. We report results for RS and our proposed FVS and HS, and for a comprehensive benchmark, we implement and compare two uncertainty-based HS variants—ActiveNeRF and Density-aware NeRF Ensembles. These variants are built upon the InstantNGP backbone, and their implementation details are provided in Supplementary.

### Evaluation on NeRF Synthetic Dataset

The results in terms of PSNR and SSIM for the InstantNGP backbone and an increasing number of training views across different view selection methods are depicted in FIG. 4a and FIG. 4b. It can be observed that FVS and HS significantly outperform other view selection methods. Conversely, view selection methods from ActiveNeRF and Density-aware NeRF Ensembles exhibit inferior performance compared to RS. This gap in performance may be attributed to two main factors: first, the uncertainty predicted does not consistently correlate with the expected reconstruction improvement for the candidate view; second, in certain scene areas, adding more views does not always result in decreased uncertainty, leading to oversampling, which is not rectified by spatial regularization. Similar results are obtained for the Plenoxel backbone and are provided in Supplementary. This disclosure also provides the runtime cost analysis, showing that the proposed FVS can reach converged quality more efficiently than RS under the same view budget.

### Evaluation on TankAndTemples Dataset

We extended our experiments to the TanksAndTemples dataset to assess the impact of different view selection methods on rendering performance for real-world data. FIG. 4c and FIG. 4d display the experimental results in terms of PSNR and SSIM. Notably, when the training view budget exceeds 30 views, FVS demonstrates superior performance, followed byHS. In contrast to the results with the NeRF Synthetic dataset, view selection based on Density-aware NeRF Ensembles achieves better performance than RS in a higher view number regime (more than 60 views). This could be attributed to the improved uncertainty quantification on realistic data of the Density-aware NeRF Ensembles, where candidate views are not uniformly distributed. Intriguingly, ActiveNeRF provides the lowest performances for our test settings, and we attribute this to its exploration of a distinct training regime for NeRF (less than 30 views) and the limited pool of training views considered (100 views).

### Ablation Study

This section introduces our ablation experiments on TanksAndTemples dataset to make a comprehensive analysis of the design of our proposed FVS and HS. We use InstantNGP as our backbone and PSNR as the evaluation metric. In general, an ablation study is a set of experiments in which components of a machine learning system are removed/replaced in order to measure the impact of these components on the performance of the system.

### Information Gain-Based Sampling

### Information Type:

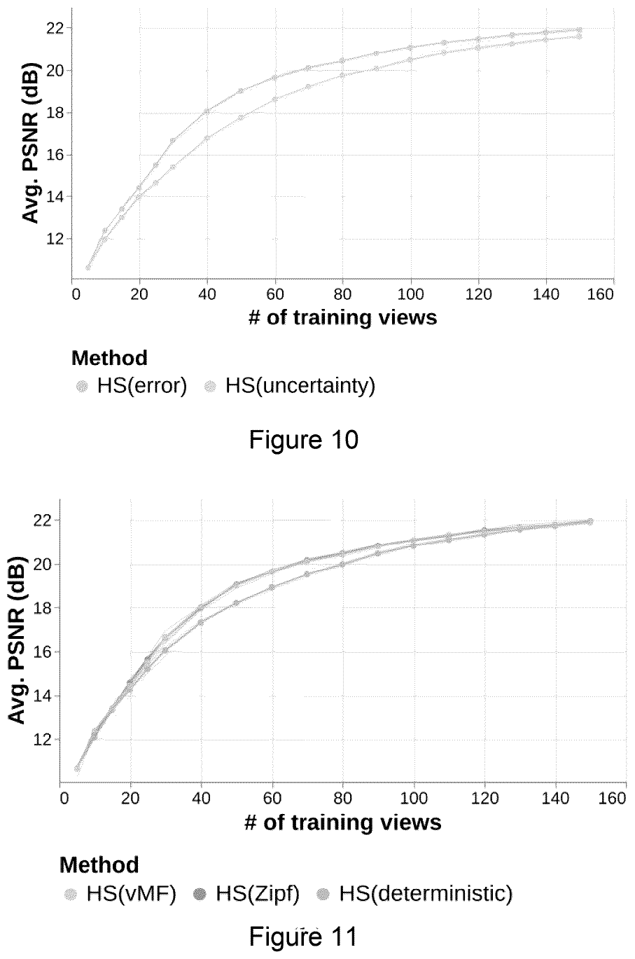

There are two potential information types for HS methods: error and uncertainty. We first explore the impact of different information gains on the performance of HS. We implemented a variant of HS based on uncertainty, which was quantified through Density-aware NeRF Ensembles. Both error and uncertainty variants utilized the vMF view sampler with applied relaxation. FIG. 10 provides a quantitative visualization of the comparison results. Error-based HS consistently outperforms uncertainty-based hs.

### Sampling Strategy:

We further investigate the impact of different probabilistic mass functions on the HS. We compared the M-vMF and the Zipf view samplers. Two Zipf view samplers were implemented with different γ settings: γ=10 and γ →∞, representing the deterministic greedy. Quantitative results shown in FIG. 11 indicate that view samplers, when combined with relaxation and consideration of nearby error measurements, can effectively select training views, thereby enhancing the performance of a NeRF model.

### Farthest View Sampling

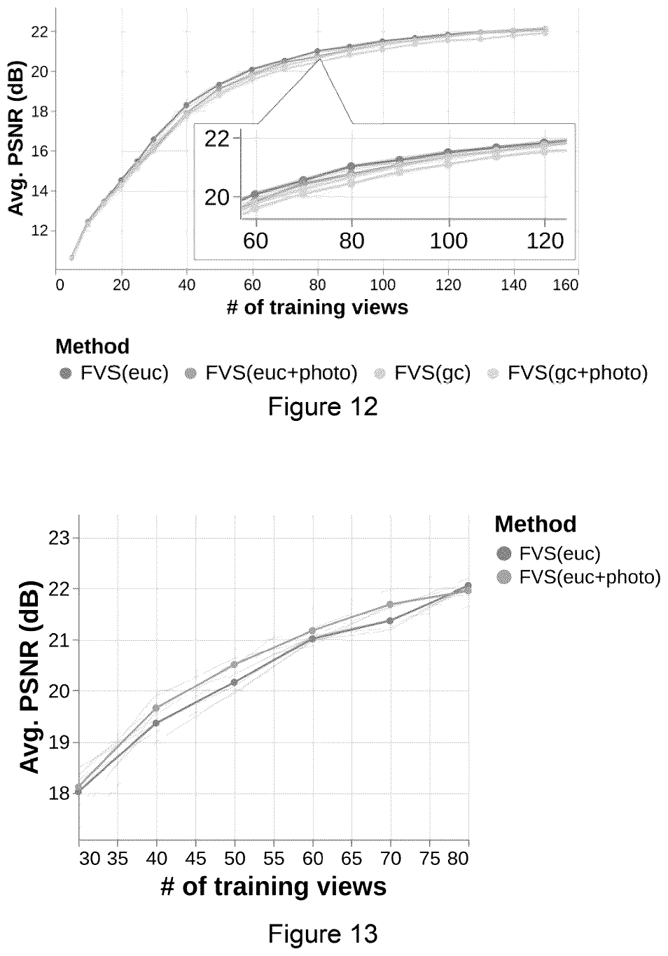

We explore four combinations of spatial distance dₛₚₐₜᵢₐₗ and photogrammetric distance dₚₕₒₜₒ. Specifically, we compare only dₛₚₐₜᵢₐₗ based on the great circle and the Euclidean distance, d_{gc} and d_{euc} respectively, as well as these two spatial distances separately combined with dₚₕₒₜₒ. For methods using d_{gcd}, we project all training views' camera centers onto a common sphere. The average quantitative results are presented in FIG. 12. This shows that selecting views solely based on d_{gcd} could be insufficient for complex real-world datasets.

### CONCLUSION

This disclosure discusses the role of view selection for NeRF in both training and testing. This disclosure provides a method to select test views to achieve a more robust and reliable evaluation. This disclosure further proposes a novel view selection assessment framework. Two view selection methods are provided for selecting training images based on a distance value: farthest view sampling (FVS), considering the distance across cameras and the diversity of their content, and an improved heuristic sampling (HS) approach by incorporating relaxation to avoid clustering. Experiments and analysis highlight the role of diversity in selected training views and advocate for spatial relaxation to address sensitivity and cluster-related challenges in heuristic methods for effective NeRF learning.

### Supplementary Information

### Sparse 3D-Reconstruction Runtime Analysis.

The proposed technique also offers the advantage of reducing the computation required for the initial sparse reconstruction used to estimate the camera parameters. Before training any NeRF, one can compute camera intrinsics and extrinsics, by solving a SfM problem, which may become costly as the number of camera n increases. Some approaches rely on four steps: feature extraction (O(n)), feature matching (O(n²)), SfM (O(n³)) and bundle adjustment (O(P³)), preventing its use for a large number of images.¹

It is worth observing that the disclosed framework and FWS could be amenable to performing view selection before solving SfM, as the presented algorithm does not require high localization accuracy. For instance, one can imagine a scenario where a real-time slam algorithm (inertial+visual odometry) estimates the camera poses. Similarly, with the coarse camera overlap, the method can swiftly compute the matrix A using fast feature matchers.

### Lloyd Relaxation.

To alleviate the aforementioned over-sampling effect, the method may comprise a modification based on the LLoyd-Max Algorithm. More specifically, given a set of k selected views with camera centers (c₁, . . . , cₖ) and m proposed views, a modification of the Lloyd iteration may be as follows:

$$μ ∈ U ( Ω ) , d = dim ( Ω ) , Ω = {S}^{2} or {R}^{3}$$

Discrete measure

$$\frac{1}{N} \sum {δ}_{{x}_{i}}$$

$$v ∈ {R}^{k \times d} , p ∈ {R}^{m \times d} c$$

$$c = \{ v , p \} ∈ {R}^{( k + n ) \times d}$$

$$i ← 1 {N}_{iter} {V}^{c} ← Voronoi ( c ) {b}^{c} ← computeBarycenter ( {V}^{c} , μ ) c ← \{ v , {b}_{k + 1 … m}^{c} \}$$

### Return c

### Implementation Details

### Re-Split the Test Set for TanksAndTemples.

The test sets in the TanksAndTemples datasets comprise one or two video clips, showcasing parts of the reconstructed scene. Notably, a significant portion of the objects are not covered by the original test cameras. This disclosure proposes a split of the test set for all four scenes in the TanksAndTemples dataset which aims at providing a more robust evaluation of different view selection methods. Firstly putting together all training and test views for a particular scene. Then, an equal number of test views were selected as in the original test set for each scene using FVS. The distance metric considered during this process encompassed both spatial distance defined above and photogrammetric distance defined above. The proposed test set is able to cover the reconstructed scene more uniformly.

### Additional Results

### Runtime Cost Analysis on the NeRF Synthetic Dataset.

This disclosure reports the runtime cost result in Table 1 measuring the training time of InstantNGP across 5 scenes of NeRF Synthetic and averaged for 10 runs (with different views). For a fixed view budget, The proposed FVS reaches the performances of the RS significantly faster (up to 4× Speedup).

TABLE 1
Averaged training time (in minutes) and standard deviation
(σ) comparisons of FVS against RS at the converged quality.

| | | |
|---|---|---|
| 2*View # | FVS | RS |

| 2-5 | mean | σ | mean | σ | 2*Speedup |
|---|---|---|---|---|---|
| 50 | 0.7 | ±0.26 | 2.6 | ±0.26 | 4.03 |
| 100 | 1.4 | ±0.43 | 2.6 | ±0.30 | 1.96 |
| 150 | 1.7 | ±0.48 | 2.7 | ±0.32 | 1.57 |

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

The invention claimed is:

1. A method for generating a three-dimensional representation of a scene, the method comprising:
accessing multiple training images of the scene, each of the multiple training images imaging the scene from a different view, the multiple training images comprising a first subset of selected training images and a second subset of remaining training images;
calculating a distance value between each of the first subset of the selected training images and each of the second subset of the remaining training images;
adding one of the multiple training images from the second subset of the remaining training images to the first subset of the selected training images based on the distance value to create a training set of the training images;
training a neural radiance field using the training set; and
generating a three-dimensional representation of the scene using the neural radiance field.

2. The method of claim 1, wherein calculating the distance value comprises calculating a distance between camera positions from which the multiple training images are captured.

3. The method of claim 2, wherein calculating the distance value comprises calculating a great-circle distance between the camera positions.

4. The method of claim 2, wherein calculating the distance value comprises calculating an Euclidean distance between the camera centres.

5. The method of claim 1, wherein calculating the distance value comprises calculating a pair-wise view similarity.

6. The method of claim 5, wherein the pair-wise view similarity is indicative of a number of points in a point cloud calculated from the multiple training images.

7. The method of claim 1, wherein adding one of the multiple training images comprises creating a probability function for each of the multiple training images and sampling the probability function to select one of the multiple training images.

8. The method of claim 1, wherein adding the one of the multiple training images comprises incrementally adding the one of the multiple training images and training the neural radiance field at each iteration.

9. The method of claim 8, wherein adding the one of the multiple training images is based on information gain of that training image.

10. The method of claim 8, wherein adding the one of the multiple training images is based on a random selection of elements that are weighted based on the distance value.

11. The method of claim 10, wherein the random selection comprises a Zipf sampler.

12. The method of claim 10, wherein the random selection comprises a von Mises-Fisher sampler.

13. The method of claim 8, wherein the method further comprises applying a quantisation algorithm to uniformize placement of the views of the selected training images.

14. The method of claim 1, wherein the method further comprises generating an output image of the scene based on the three-dimensional representation.

15. The method of claim 14, wherein the output image is from a user-defined view different from the view of each of the multiple training images.

16. A non-transitory, computer readable medium with program code stored thereon that, when executed by a computer, causes the computer to perform the method of claim 1.

17. A computer system comprising one or more processors configured to perform the method of claim 1.
